(19) United States
(12) Patent Application Publication
(10) Pub. No.: US 2019/0230934 A1
(43) Pub. Date: Aug. 1, 2019

(54) Grassy Plant Treatment

(71) Applicant: Phyton Corporation, Bloomington, MN (US)

(72) Inventor: William Gullickson, Bloomington, MN (US)

(21) Appl. No.: 16/262,532

(22) Filed: Jan. 30, 2019

Related U.S. Application Data
(60) Provisional application No. 62/623,811, filed on Jan. 30, 2018.

(51) Int. Cl. A01N 59/20; A01N 59/16

(52) U.S. Cl. CPC A01N 59/20; A01N 59/16

(57) ABSTRACT

Processes for treating grassy plants with copper-containing compositions are provided. The treated plants display increased grain yield, increased uptake of essential plant nutrients, and/or increased copper uptake.

### CLAIM OF PRIORITY

This application claims priority to U.S. Provisional Application Ser. No. 62/623,811, filed on Jan. 30, 2018, the entire contents of which are hereby incorporated by reference.

### TECHNICAL FIELD

This invention relates to treatments for grassy plants, including field crops, grains, and grasses, and more particularly to providing copper-containing treatments to grassy plants for increasing yield, copper uptake, and essential nutrient uptake in the plants.

### BACKGROUND

Copper is an essential nutrient of grassy plants, and can be involved in plant metabolic processes such as photosynthesis and respiration. The bioavailability of copper in some soils is limited, and some growing practices, including certain types of fertilization, can lead to lower copper bioavailability. Copper deficiency in grassy plants can lead to sterility and decreased yields, while excess application of copper can be toxic to the plants.

### SUMMARY

This document provides methods for treating grassy plants with copper-containing compositions. In some embodiments, the copper-containing compositions are copper biocide compositions. In some embodiments, the methods can include applying an aqueous composition comprising from about 1% to about 6% by weight copper metal at an application rate of from about 50 ml/ha to about 2000 ml/ha.

Some exemplary methods described herein include applying copper biocide compositions to grassy plants at low concentrations or amounts. For example, in some embodiments, the copper-containing compositions are applied such that each hectare of plants receives about 1.00 g copper to about 80.00 g copper. In some embodiments, the methods described herein may include applying a first application of copper-containing compositions to grassy plants at or before panicle initiation.

In one aspect, a method is provided herein for treating a grassy plant. The method includes applying a first application of an aqueous composition to the plant. The aqueous compositions can comprise a copper compound, and the amount of copper metal in the composition is from about 1% to about 6% by weight based on the weight of the composition. The aqueous composition can be applied to one or more plants at an application rate of about 200 ml per hectare to about 1200 ml per hectare to form a treated plant.

In some implementations, the first application can be applied prior to onset of panicle initiation in the plant. In some implementations, the first application can be applied at, within about 5 days prior to, or within about 5 days after onset of panicle initiation in the plant. In some implementations, the first application can be applied 20 to 85 days after germination of the grassy plant. The first application can include an application rate of about 1.00 g copper metal per hectare to about 80.00 g copper metal per hectare. In some implementations, the first application can be a foliar spray application.

In some implementations, the composition can further comprise tannic acid. In some implementations, the composition can further comprise ammonium formate. The composition can, in some implementations, comprise a tannate complex of picro cupric ammonium formate in aqueous solution.

In some implementations, the copper compound in the aqueous composition can be selected from, e.g., copper sulfate, copper chlorate, copper nitrate, copper chloride, and combinations thereof. In some implementations, the composition can further comprise a zinc compound. The amount of zinc metal in can be between 1% and 5% by weight based upon the weight of the composition. The zinc compound can be a water-soluble zinc compound selected from, e.g., zinc sulfate, zinc chlorate, zinc nitrate, zinc chloride, and combinations thereof. In some implementations, the composition can further comprise a manganese compound. The amount of manganese metal can be between 0.1% and 0.5% by weight of the composition. The manganese compound can be a water-soluble manganese compound selected from the group consisting of manganese sulfate, manganese chlorate, manganese nitrate, manganese chloride, and combinations thereof. In some implementations, the composition can further comprise a surfactant. The surfactant can include an alkali metal alkyl sulfate, such as sodium lauryl sulfate.

In some implementations, the method can further comprise applying to the treated plant a second application of the aqueous composition. The second application can be applied at an application rate of about 200 ml per hectare to about 1200 ml per hectare. In some implementations, the second application can be applied to the treated plant at, within about 5 days prior to, or within about 5 days after onset of boot stage of the treated plant. In some implementations, the second application can be applied to the treated plant from about 25 days to about 50 days after the first application. The second application can include an application rate of about 1.00 g copper metal per hectare to about 80.00 g copper metal per hectare. In some implementations, the second application can be a foliar spray application.

In some implementations, a grain yield of a treated plant can be greater than a grain yield of an untreated plant of the same plant variety grown under similar conditions for a similar amount of time. In some implementations, the grain yield of a treated plant is at least 10% greater than the grain yield of an untreated plant of the same plant variety grown under similar conditions for a similar amount of time. In some implementations, the uptake of one or more nutrients selected from calcium, iron, magnesium, manganese, potassium, selenium, zinc, and combinations thereof, in a treated plant is greater than the uptake of the same one or more nutrients in an untreated plant or the same plant variety grown under similar conditions for a similar amount of time. In some implementations, copper uptake in a treated plant is greater than copper uptake in an untreated plant of the same plant variety grown under similar conditions for a similar amount of time. In some implementations, copper uptake in a treated plant is greater in the foliage of the treated plant than in a grain of the treated plant.

The methods can be practiced on a field crop, a grain, or a grass, such as, e.g., plants of the Poaceae family, including the Pooideae subfamily, plants of the Brassicaceae family, and plants of the Asteraceae family. Exemplary grassy plants include wheat, barley, oat, rapeseed, safflower, and turf grasses. In some implementations, the plant is not a rice plant.

In some implementations, the plant is in soil and the method further comprises testing the soil for copper content prior to the first application. In some implementations, the soil has a copper content of less than 2.5 mg/kg.

The methods described herein can provide several advantages. First, applying copper-containing compositions to grassy plants according to the methods described herein can lead to increased copper uptake in the treated grassy plants. Copper is an essential plant nutrient and is involved in several metabolic processes in grassy plants. Since copper is typically immobile in plants, correction of copper deficiency can be complicated. However, in some embodiments, increasing copper uptake by the methods described herein can correct copper deficiencies in the plants. In some embodiments, increasing copper uptake by the methods described herein can occur without excessive copper uptake in the seeds or grains of the plants. Excessive copper concentrations in harvested food products, such as the seed or grain, may, in some circumstances, be unacceptable for consumption.

Second, applying copper-containing compositions according to the methods described herein can lead to increased uptake of essential plant nutrients. Essential plant nutrients keep plants healthy, protect plants from disease, and aid in plant reproduction.

Third, applying copper-containing compositions according to the methods described herein can lead to increased yield in the plants. In some embodiments, plants treated by the methods described herein exhibit increased biomass, increased plant matter yield, and/or increased grain yield.

Fourth, applying copper-containing compositions according to the methods described herein can, in some embodiments, provide copper to the grassy plants without resulting in toxic effects. Copper-containing compositions have traditionally been applied to plants as a biocide in somewhat high concentrations to protect against bacteria, fungi, and other diseases. Typically these applications of copper-containing biocides occur at late plant life cycle stages to reduce toxicity to the plant, but late stage application of copper does not supply the copper essential for earlier life cycle stages such as reproduction. High application rates of copper can be toxic to plants, particularly at early life cycle stages. However, in some embodiments, copper-containing compositions applied according to the methods described herein do not produce toxic effects in the plants.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

For the terms “for example” and “such as,” and grammatical equivalences thereof, the phrase “and without limitation” is understood to follow unless explicitly stated otherwise. As used herein, the term “about” is meant to account for variations due to experimental error. As used herein, the singular forms “a,” “an,” and “the” are used interchangeably and include plural referents unless the context clearly dictates otherwise.

As used herein, the term “compound” includes hydrates.

Also herein, the recitations of numerical ranges by endpoints include all numbers subsumed within that range (e.g., 1 to 5 includes 1, 1.5, 2, 2.75, 3, 3.80. 4, 5, etc.).

Other features and advantages of the invention will be apparent from the following detailed description and figures, and from the claims.

### DETAILED DESCRIPTION

The present disclosure is directed to methods of treating grassy plants such as field crops, grains, and grasses, by applying copper-containing compositions to the plants. It has been surprisingly discovered that, in some embodiments, application of copper-containing compositions ordinarily used as biocides, can have advantageous effects on the nutrient composition and yield of plants when applied at lower concentrations and different life cycle stages than when used as biocides.

Copper-containing compositions useful in the methods described herein can contain from about 1% to about 6% by weight copper metal. In some embodiments, the copper-containing compositions contain from about 4% to about 6% by weight copper metal, from about 1% to about 2% by weight copper metal, from about 1.5% to about 1.6% by weight copper metal, from about 1.9% to about 2.0% by weight copper metal, from about 4.3% to about 4.4% by weight copper metal, or from about 5.3% to about 5.5% by weight copper metal.

The compositions can be applied to a particular plant or target area in one or more applications as needed. In some embodiments, the copper-containing compositions can be applied to the plants as a first application, or as first and second applications, to form a treated plant. The typical field application rate, or amount, per hectare can range from about 50 ml per hectare to about 2000 ml per hectare, about 200 ml per hectare to about 1200 ml per hectare, about 400 ml per hectare to about 1100 ml per hectare, about 500 ml per hectare to about 1000 ml per hectare, about 400 ml per hectare to about 600 ml per hectare, or about 900 to about 1100 ml per hectare. In some embodiments, the copper-containing compositions can be applied to the plants in a first application, or first and second applications, at an application rate of about 500 ml/ha per application. In some embodiments, the copper-containing compositions can be applied to the plants in a first application, or first and second applications, at an application rate of about 1000 ml/ha per application. In some embodiments, the second application can be applied at the same rate or amount as the first application, while in other embodiments, the second application can have a different application rate or amount.

In some embodiments, the first and/or second application can include applying the compositions at a rate, or amount, of, for example, about 1.00 g copper metal per hectare to about 80.00 g copper metal, about 1.20 g copper metal per hectare to about 77.00 g copper metal per hectare, about 1.00 g copper metal per hectare to about 5.00 g copper metal per hectare, about 1.20 g copper metal per hectare to about 1.80 g copper metal per hectare, about 70.00 g copper metal per hectare to about 80.00 g copper metal per hectare, or about 76.00 g copper metal per hectare to about 77.00 g copper metal per hectare. In some embodiments, the first and/or second application can include applying the compositions at a rate of about 1.28 g copper metal per hectare per application. In some embodiments, the first and/or second application can include applying the compositions at a rate of about 76.8 g copper metal per hectare per application.

In some embodiments, the copper-containing compositions are applied to the grassy plants at certain life cycle stages. Grassy plants undergo multiple life stages and phases. Initially, grassy plants start out in a dormant seed phase. Next, the germination phase breaks dormancy and the seed grows shoots and roots. Once the seed develops into a seedling, the early vegetative phase begins, in which more leaves and roots develop. This seedling stage ends when the tillering stage, or late vegetative phase, begins. During tillering, tillers develop until the plant reaches its maximum number of tillers. Then the plant enters the prebooting stage the end of the vegetative phase and beginning of the reproductive phase. During prebooting, more leaves develop and the plant continues elongation until it stops growing in height, just before panicle initiation. In some cases, panicle initiation can occur anywhere from 21 days to 10 months from germination, depending on the species, variety, and the growing conditions. Following panicle initiation, the plant undergoes panicle differentiation and development and then enters the booting stage, during which panicle development is completed. In some cases, the booting stage can occur anywhere from 20 days to 50 days after panicle initiation, depending on the species, variety, and the growing conditions. The plant then enter heading stage and progresses to the flowering stage, at which point the ripening phase begins. During the ripening phase, fertilization, grain formation, and grain filling occur until the grain reaches maturity. The length and timing of each stage or phase can differ depending on plant variety and growing conditions such as weather conditions.

In some embodiments of the method, a first application of a copper-containing composition is applied to a grassy plant prior to onset of panicle initiation in the plant. In some embodiments, a first application of a copper-containing composition is applied to a plant at, within about 5 days prior to, or within about 5 days after onset of panicle initiation in the plant. In some embodiments, a first application of a copper-containing composition is applied to a grassy plant at 20 to 85 days after germination of the plant, 25 to 55 days after germination of the plant, 25 to 40 days after germination of the plant, or 30 days after germination of the plant.

In some embodiments, a second application of a copper-containing composition described herein can be applied at boot stage to a plant that was treated with a first application of a copper-containing composition. In some embodiments, a second application of a copper-containing composition is applied to a grassy plant within about 5 days prior to, or within about 5 days after onset of boot stage of the treated plant. In some embodiments, a second application of a copper-containing composition is applied to a grassy plant at about 25 days to about 50 days after the first application, about 25 days to about 35 days after the first application, or about 30 days after the first application. In some embodiments, the second application can be applied at the same rate or amount as the first application, while in other embodiments, the second application can have a different application rate or amount.

The copper-containing compositions can be applied directly to the plant surfaces, such as directly to the foliage of the plant, in the processes described herein, using conventional techniques, such as spraying, painting, or dipping. In some embodiments, the first application of copper-containing compositions is applied by foliar application, which can include spraying the composition on at least a portion of the plant. In some embodiments, the first application of copper-containing compositions is applied by soil drench or flooding application. In some embodiments, the second application of copper-containing compositions is applied by foliar application. In some embodiments, the second application of copper-containing compositions is applied by soil drench or flooding application.

Copper-containing compositions useful in the methods described herein can include a copper compound in which the amount of copper metal is between 1% and 6% by weight based upon the weight of the composition. Examples of suitable copper compounds include water-soluble copper compounds such as copper sulfate, copper chlorate, copper nitrate, copper chloride, and combinations thereof.

In some embodiments, the copper-containing compositions can also include tannic acid. In some embodiments, the copper-containing compositions can include ammonium formate. The copper-containing compositions can also include one or more surfactants. In some embodiments, the surfactant can be an alkali metal alkyl sulfate, such as sodium lauryl sulfate.

The copper-containing compositions useful in the methods described herein can be prepared by combining the ingredients in an agriculturally-acceptable non-toxic carrier, such as an aqueous carrier. Other ingredients may be included as well. Examples of suitable additional ingredients include tannic acid, picric acid, pigments (e.g., SMC white, which also can function as a solvent/carrier) to facilitate visualization upon application to a plant surface, and ammonium salts (e.g., ammonium formate). If desired, agents to adjust the viscosity and/or adherent properties of the composition may be included. Examples include water-soluble polymers such as polyvinylpyrrolidone, polyoxyethylene, polyvinyl alcohol, and poyacrylamide.

In some embodiments, the copper-containing compositions can comprise a tannate complex of picro cupric ammonium formate in aqueous solution. The compositions can further comprise a surfactant. In some embodiments, the tannate complex of picro cupric ammonium formate is comprised of one mole of a water soluble copper salt reacted with 2 to 2.9 moles of ammonium formate, and for each 100 parts by dry weight of cupric ammonium formate the complex includes from about 2 to 5 parts by weight of picric acid and about 0.5 to 3.5 parts by weight of tannic acid combined with about 2 to 10 parts by weight of surfactant sufficient to prevent separation of the tannate complex. In some embodiments, the tannate complex can be admixed in amount from about 0.05% to about 60% by weight with an agriculturally acceptable non-toxic carrier.

Copper-containing compositions useful in the methods described herein can, in some embodiments, further comprise a zinc compound. Examples of suitable zinc compounds include water-soluble zinc compounds selected from zinc sulfate, zinc chlorate, zinc nitrate, zinc chloride, and combinations thereof. The amount of zinc metal in the composition can be between 1% and 5% by weight based upon the weight of the composition.

In some embodiments, the copper-containing compositions can further include a manganese compound. Examples of suitable manganese compounds include water-soluble manganese compounds selected from the group consisting of manganese sulfate, manganese chlorate, manganese nitrate, manganese chloride, and combinations thereof. The amount of manganese metal in the composition can be between 0.1% and 0.5% by weight based upon the weight of the composition.

In some embodiments, application of the copper-containing compositions can lead to increased copper uptake in the treated plant, as compared to a similar untreated plant of the same plant variety grown under similar conditions, for a similar amount of time. When the copper-containing compositions are applied according to some embodiments of the processes described herein, the increase in copper uptake can be limited to foliage of the plant. In other embodiments, the copper uptake may increase in the seed or grain of the plant, as well as in the foliage, but the foliage can have a greater increase in copper uptake than any increase in copper uptake in a seed of the treated plant. In other embodiments, the copper uptake may increase throughout the foliage and seeds in similar amounts.

Application of the copper-containing compositions can, in some embodiments, lead to increased uptake in the treated plant of one or more essential nutrients, such as calcium, iron, magnesium, manganese, potassium, selenium, zinc, or combinations thereof, as compared to a similar untreated plant of the same plant variety grown under similar conditions, for a similar amount of time. In some embodiments, the increase in uptake of essential nutrients can be detected at the early flowering stage. In some embodiments, the increase in uptake of essential nutrients can be detected at the early flowering stage but is not detected at harvest.

In some embodiments, application of the copper-containing compositions can lead to increased yield in the treated plant as compared to a similar untreated plant of the same plant variety grown under similar conditions, for a similar amount of time. Increased yield can refer to, for example, increased biomass yield, increased plant matter yield, or increased grain yield. Grain yield can refer to the amount of grain or seed produced by the grassy plants. In some embodiments, application of the copper-containing compositions can lead to at least a 5%, at least an 8%, at least a 10%, at least a 15%, or at least a 20% increase in grain yield or plant matter yield as compared to an untreated plant. In some embodiments, application of the copper-containing compositions can lead to at least a 12% increase in grain yield or plant matter yield as compared to an untreated plant. In some embodiments, application of the copper-containing compositions can lead to at least a 24% increase in grain yield or plant matter yield as compared to an untreated plant.

Plants treated by the processes described herein can include a variety of grassy plants, such as field crops, grains, and grasses. In some embodiments, plants treated by the processes herein can include plants of the Poaceae family, including the Pooideae subfamily, plants of the Brassicaceae family, and plants of the Asteraceae family. For example, the plants can include wheat, barley, oat, rapeseed, safflower, or turf grasses. In some embodiments, plants treated by the methods described herein do not include rice plants.

In some embodiments of the method, the soil in which the plants are growing can be tested for copper content prior to the first application of a copper-containing composition. The copper-containing composition can be applied, in some embodiments, to plants growing in soil having a copper content of, e.g., less than 5 mg/kg, less than 4 mg/kg, less than 3 mg/kg, less than 2.5 mg/kg, less than 2 mg/kg, or less than 1 mg/kg. In some embodiments of the method, the compositions are applied to plants that have been determined to be deficient in copper. Copper deficiency in grassy plants can be determined by conventional means, such as by plant symptoms, or by elemental analysis. A determination of whether a plant is deficient in copper can depend on the particular plant type and plant variety. In some embodiments of the method, the compositions are applied to plants growing in soil that has been determined to be deficient in copper. Copper deficiency in soil can be determined by conventional means, such as by sampling soil at one or more depths. As can be appreciated, a determination of whether a soil or a plant is deficient in copper can depend on the particular plant type and plant variety.

Some non-limiting exemplary embodiments are described in Embodiments 1-40 below:

Embodiment 1. A method of treating a grassy plant comprising:

applying to said plant a first application of an aqueous composition comprising a copper compound in which the copper metal is from about 1% to about 6% by weight based on the weight of the composition, at an application rate of about 200 ml per hectare to about 1200 ml per hectare to form a treated plant.

Embodiment 2. The method of embodiment 1, wherein said first application is applied prior to onset of panicle initiation in said plant.

Embodiment 3. The method of embodiment 1, wherein said first application is applied at, within about 5 days prior to, or within about 5 days after onset of panicle initiation in said plant.

Embodiment 4. The method of any one of embodiments 1-3, wherein said first application is applied within about 5 days prior to onset of panicle initiation in said plant.

Embodiment 5. The method of any one of embodiments 1-4, wherein said first application is applied 20 to 85 days after germination of said grassy plant.

Embodiment 6. The method of any one of embodiments 1-5, wherein said first application is applied 30 days after germination of said grassy plant.

Embodiment 7. The method of any one of embodiments 1-6, wherein said first application comprises applying said composition at an application rate of about 500 ml per hectare to about 1000 ml per hectare.

Embodiment 8. The method of any one of embodiments 1-6, wherein said first application comprises applying said composition at an application rate of about 400 ml per hectare to about 600 ml per hectare.

Embodiment 9. The method of any one of embodiments 1-6, wherein said first application comprises applying said composition at an application rate of about 900 ml per hectare to about 1100 ml per hectare.

Embodiment 10. The method of any one of embodiments 1-9, wherein said first application of said composition comprises applying said composition at an application rate of about 1.00 g copper metal per hectare to about 80.00 g copper metal per hectare.

Embodiment 11. The method of any one of embodiments 1-9, wherein said first application of said composition comprises applying said composition at an application rate of about 1.20 g copper metal per hectare to about 77.00 g copper metal per hectare.

Embodiment 12. The method of any one of embodiments 1-9, wherein said first application of said composition comprises applying said composition at an application rate of about 1.00 g to about 10.00 g copper metal per hectare.

Embodiment 13. The method of any one of embodiments 1-9, wherein said first application of said composition comprises applying said composition at an application rate of about 60.00 g to about 80.00 g copper metal per hectare.

Embodiment 14. The method of any one of embodiments 1-13, wherein said composition further comprises:

tannic acid.

Embodiment 15. The method of embodiment 14, wherein said composition further comprises:

ammonium formate.

Embodiment 16. The method of any one of embodiments 1-15, wherein said composition comprises a tannate complex of picro cupric ammonium formate in aqueous solution.

Embodiment 17. The method of any one of embodiments 1-16, wherein said copper compound is a water-soluble copper compound selected from the group consisting of copper sulfate, copper chlorate, copper nitrate, copper chloride, and combinations thereof.

Embodiment 18. The method of embodiment 17, wherein said water-soluble copper compound is copper sulfate.

Embodiment 19. The method of any one of embodiments 1-18, wherein said composition further comprises:

a zinc compound.

Embodiment 20. The method of embodiment 19, wherein the amount of zinc metal in said zinc compound is between 1% and 5% by weight based upon the weight of said composition.

Embodiment 21. The method of any one of embodiments 19-20, wherein said zinc compound is a water-soluble zinc compound selected from the group consisting of zinc sulfate, zinc chlorate, zinc nitrate, zinc chloride, and combinations thereof

Embodiment 22. The method of any one of embodiments 1-21, wherein said composition further comprises:

a manganese compound.

Embodiment 23. The method of embodiment 22, wherein the amount of manganese metal in said manganese compound is between 0.1% and 0.5% by weight of said composition.

Embodiment 24. The method of any one of embodiments 22-23, wherein said manganese compound is a water-soluble manganese compound selected from the group consisting of manganese sulfate, manganese chlorate, manganese nitrate, manganese chloride, and combinations thereof.

Embodiment 25. The method of any one of embodiments 1-24, wherein said composition further comprises a surfactant.

Embodiment 26. The method of embodiment 25, wherein said surfactant is an alkali metal alkyl sulfate.

Embodiment 27. The method of any one of embodiments 25-26, wherein said surfactant is sodium lauryl sulfate.

Embodiment 28. The method of any one of embodiments 1-27, wherein said first application is a foliar spray application.

Embodiment 29. The method of any one of embodiments 1-28, further comprising applying to said treated plant a second application of said composition at an application rate of about 200 ml per hectare to about 1200 ml per hectare.

Embodiment 30. The method of embodiment 29, wherein said second application is applied to said treated plant at, within about 5 days prior to, or within about 5 days after onset of boot stage of said treated plant.

Embodiment 31. The method of embodiment 29, wherein said second application is applied to said treated plant from about 25 days to about 50 days after said first application.

Embodiment 32. The method of any one of embodiments 29-31, wherein said second application is a foliar spray application.

Embodiment 33. The method of any one of embodiments 29-32, wherein said second application comprises applying said composition at an application rate of about 500 ml per hectare to about 1000 ml per hectare.

Embodiment 34. The method of any one of embodiments 29-33, wherein said second application comprises applying said composition at an application rate of about 1.00 g copper per hectare to about 80.00 g copper per hectare.

Embodiment 35. The method of any one of embodiments 29-33, wherein said second application comprises applying said composition at an application rate of about 1.20 g copper per hectare to about 77.00 g copper per hectare.

Embodiment 36. The method of any one of embodiments 1-35, wherein a grain yield of said treated plant is greater than a grain yield of an untreated plant of the same plant variety grown under similar conditions for a similar amount of time.

Embodiment 37. The method of embodiment 36, wherein said grain yield of said treated plant is at least 10% greater than the grain yield of an untreated plant of the same plant variety grown under similar conditions for a similar amount of time.

Embodiment 38. The method of embodiment 36, wherein said grain yield of said treated plant is at least 20% greater than the grain yield of an untreated plant of the same plant variety grown under similar conditions for a similar amount of time.

Embodiment 39. The method of embodiment 36, wherein said grain yield of said treated plant is at least 25% greater than the grain yield of an untreated plant of the same plant variety grown under similar conditions for a similar amount of time.

Embodiment 40. The method of any one of embodiments 1-39, wherein the plant is selected from a plant of the Brassicaceae family, a plant of the Asteraceae family, or a plant of the Pooideae subfamily of the Poaceae family.

Embodiment 41. The method of any one of embodiments 1-40, wherein the plant is selected from wheat, barley, oat, rapeseed, safflower, and turf grasses.

Embodiment 42. The method of any one of embodiments 1-41, wherein the uptake of one or more nutrients selected from calcium, iron, magnesium, manganese, potassium, selenium, zinc, and combinations thereof, in said treated plant is greater than the uptake of said one or more nutrients in an untreated plant of the same plant variety grown under similar conditions for a similar amount of time.

Embodiment 43. The method of any one of embodiments 1-42, wherein copper uptake in said treated plant is greater than copper uptake in an untreated plant of the same plant variety grown under similar conditions for a similar amount of time.

Embodiment 44. The method of embodiment 43, wherein copper uptake in said treated plant is greater in the foliage of said treated plant than in a grain of said treated plant.

Embodiment 45. The method of any one of embodiments 1-44, wherein said plant is in soil and further comprising testing said soil for copper content prior to said first application.

Embodiment 46. The method of embodiment 45, wherein said soil has a copper content of less than 2.5 mg/kg.

Embodiment 47. The method of any one of embodiments 1-46, wherein the plant is not a rice plant.

### Other Embodiments

A number of embodiments of the invention have been described. It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of treating a grassy plant comprising:
applying to said plant a first application of an aqueous composition comprising a copper compound in which the copper metal is from about 1% to about 6% by weight based on the weight of the composition, at an application rate of about 200 ml per hectare to about 1200 ml per hectare to form a treated plant.

2. The method of claim 1, wherein said first application is applied prior to onset of panicle initiation in said plant.

3. The method of claim 1, wherein said first application is applied at, within about 5 days prior to, or within about 5 days after onset of panicle initiation in said plant, or 20 to 85 days after germination of said grassy plant.

4. The method of claim 1, wherein said first application comprises applying said composition at an application rate of about 400 ml per hectare to about 600 ml per hectare, about 900 ml per hectare to about 1100 ml per hectare, about 1.00 g to about 10.00 g copper metal per hectare, or about 60.00 g to about 80.00 g copper metal per hectare.

5. The method of claim 1, wherein said composition further comprises:
tannic acid, ammonium formate, a zinc compound, a manganese compound, a surfactant, or combinations thereof.

6. The method of claim 1, wherein said composition comprises a tannate complex of picro cupric ammonium formate in aqueous solution.

7. The method of claim 1, wherein said copper compound is a water-soluble copper compound selected from the group consisting of copper sulfate, copper chlorate, copper nitrate, copper chloride, and combinations thereof.

8. The method of claim 5, wherein the composition comprises a zinc compound and the amount of zinc metal in said zinc compound is between 1% and 5% by weight based upon the weight of said composition.

9. The method of claim 5, wherein the composition comprises a manganese compound and the amount of manganese metal in said manganese compound is between 0.1% and 0.5% by weight of said composition.

10. The method of claim 5, wherein the composition comprises a surfactant and said surfactant is an alkali metal alkyl sulfate.

11. The method of claim 1, wherein said first application is a foliar spray application.

12. The method of claim 1, further comprising applying to said treated plant a second application of said composition at an application rate of about 200 ml per hectare to about 1200 ml per hectare.

13. The method of claim 12, wherein said second application is applied to said treated plant at, within about 5 days prior to, or within about 5 days after onset of boot stage of said treated plant, or from about 25 days to about 50 days after said first application.

14. The method of claim 12, wherein said second application comprises applying said composition at an application rate of about 1.00 g copper per hectare to about 80.00 g copper per hectare.

15. The method of claim 1, wherein a grain yield of said treated plant is greater than a grain yield of an untreated plant of the same plant variety grown under similar conditions for a similar amount of time.

16. The method of claim 1, wherein the plant is selected from a plant of the Brassicaceae family, a plant of the Asteraceae family, or a plant of the Pooideae subfamily of the Poaceae family.

17. The method of claim 1, wherein the uptake of one or more nutrients selected from calcium, iron, magnesium, manganese, potassium, selenium, zinc, and combinations thereof, in said treated plant is greater than the uptake of said one or more nutrients in an untreated plant of the same plant variety grown under similar conditions for a similar amount of time.

18. The method of claim 1, wherein copper uptake in said treated plant is greater than copper uptake in an untreated plant of the same plant variety grown under similar conditions for a similar amount of time.

19. The method of claim 18, wherein copper uptake in said treated plant is greater in the foliage of said treated plant than in a grain of said treated plant.

20. The method of claim 1, wherein the plant is not a rice plant.
